(19) United States
(12) Patent Application Publication
(10) Pub. No.: US 2025/0299668 A1
(43) Pub. Date: Sep. 25, 2025

(54) TECHNIQUES FOR DETERMINING CONVERSATIONAL INTENT

(71) Applicant: Snap Inc., Santa Monica, CA (US)

(72) Inventors: Ilteris Kaan Canberk, Marina Del Rey, CA (US); Matthew Hallberg, Los Angeles, CA (US); Mitchell Kuppersmith, College Station, TX (US)

(21) Appl. No.: 18/612,539

(22) Filed: Mar. 21, 2024

(51) Int. Cl. G10L 15/18; B60H 1/00; B60R 16/037; G10L 15/183; G10L 15/22; G10L 25/87

(52) U.S. Cl. CPC G10L 15/1815; B60H 1/00757; B60R 16/0373; G10L 15/183; G10L 15/22; G10L 25/87; G10L 2015/223

(57) ABSTRACT

The present disclosure relates to systems and methods for enhancing the interaction between users and automated agents, such as digital assistants, by employing Large Language Models (LLMs) to infer the intent of spoken language. The invention involves continuously monitoring ambient audio, converting speech to text, and utilizing LLMs to determine whether spoken language is intended for the automated agent. A structured prompt, including the converted text and specific instructions, is sent to the LLM, which is fine-tuned to process domain-specific prompts. The LLM provides a structured output in a standardized format, indicating the user's intent. The system may involve multiple prompts to perform separate tasks, such as identifying intent and generating additional context-specific data. This approach facilitates a more natural and intuitive user experience by eliminating the need for wake words and allowing seamless conversational interaction with virtual assistants across various platforms and devices.

### TECHNICAL FIELD

The present application relates to the technical field of artificial intelligence (AI), and more specifically, to automated agents or assistants, frequently referred to as digital agents, digital assistants, virtual agents, virtual assistants, and chatbots. More specifically, the present application relates to the development and implementation of advanced conversational interfaces that leverage Large Language Models (LLMs) for the purpose of inferring the conversational intent of spoken language.

### BACKGROUND

Automated agents or assistants, exemplified by widely recognized platforms such as Siri®, Amazon Alexa®, Google Assistant®, and others, represent a significant advancement in human-computer interaction. These automated agents or assistants are designed to comprehend and respond to natural, spoken language, enabling users to interact with technology in a conversational manner. Unlike traditional interfaces that rely on text input, for example, from a keyboard, touch-screen interface, or similar input device, these automated agents and assistants receive audible input and leverage sophisticated natural language processing (NLP) algorithms and speech recognition technologies to interpret user commands and queries, and provide relevant responses. One significant advantage arising from this type of interface is that it is hands-free—that is, a person can interact with the automated agent without using his or her hands to provide input and control.

The evolution of these automated agents and assistants has been driven by advancements in various technologies and the increasing demand for intuitive and efficient ways to access information, perform tasks, and control various devices and services. By integrating speech and audio-based command interfaces, these automated agents and assistants offer users a seamless and hands-free experience, allowing them to engage with technology effortlessly in various contexts, including smartphones, smart speakers, head-worn computing devices, infotainment interfaces for automobiles, and other devices.

### BRIEF DESCRIPTION OF THE SEVERAL VIEWS OF THE DRAWINGS

In the drawings, which are not necessarily drawn to scale, like numerals may describe similar components in different views. To easily identify the discussion of any particular element or act, the most significant digit or digits in a reference number refer to the figure number in which that element is first introduced. Some non-limiting examples are illustrated in the figures of the accompanying drawings in which:

FIG. 1 is a diagram illustrating an example of a conventional automated agent, which relies on a wake word detection model for identifying when a user has spoken a specific word or phrase (e.g., a wake word), indicating an express intent to invoke some functionality of the automated agent.

FIG. 2 is a diagram illustrating an example of an automated agent, which leverages the combination of an automatic speech recognition model or speech-to-text model and a Large Language Model (LLM) to infer the intent of a user, based on captured spoken words, according to some examples.

FIG. 3 is a diagram illustrating an example of the interactions between a user of an automated agent leveraging an LLM to infer the intent of the user, based on words spoken by the user, according to some examples.

FIG. 4 is a flow diagram illustrating the method operations of a method for determining user intent for interaction with a domain-specific automated agent, according to some examples.

FIG. 5 is a diagram illustrating an alternative system architecture for the automated agent, where the automated agent is integrated to operate with various client applications, consistent with some examples.

FIG. 6 is a diagrammatic representation of a machine in the form of a computer system within which a set of instructions may be executed to cause the machine to perform any one or more of the methodologies discussed herein, according to some examples.

FIG. 7 is a block diagram showing a software architecture within which examples may be implemented.

### DETAILED DESCRIPTION

The present application relates to the technical field of artificial intelligence (AI), and more specifically, to automated, AI-based agents, sometimes referred to as digital agents, digital assistants, virtual agents, virtual assistants or chatbots. More specifically, the present application relates to advanced natural language, conversational interfaces that leverage Large Language Models (LLMs) for the purpose of inferring the intent of a user in interacting with an automated agent, based on spoken words of the user. In the following description, for purposes of explanation, numerous specific details are set forth to provide a thorough understanding of the various aspects of different embodiments of the present invention. It will be evident, however, to one skilled in the art, that the present invention may be practiced without all of these specific details.

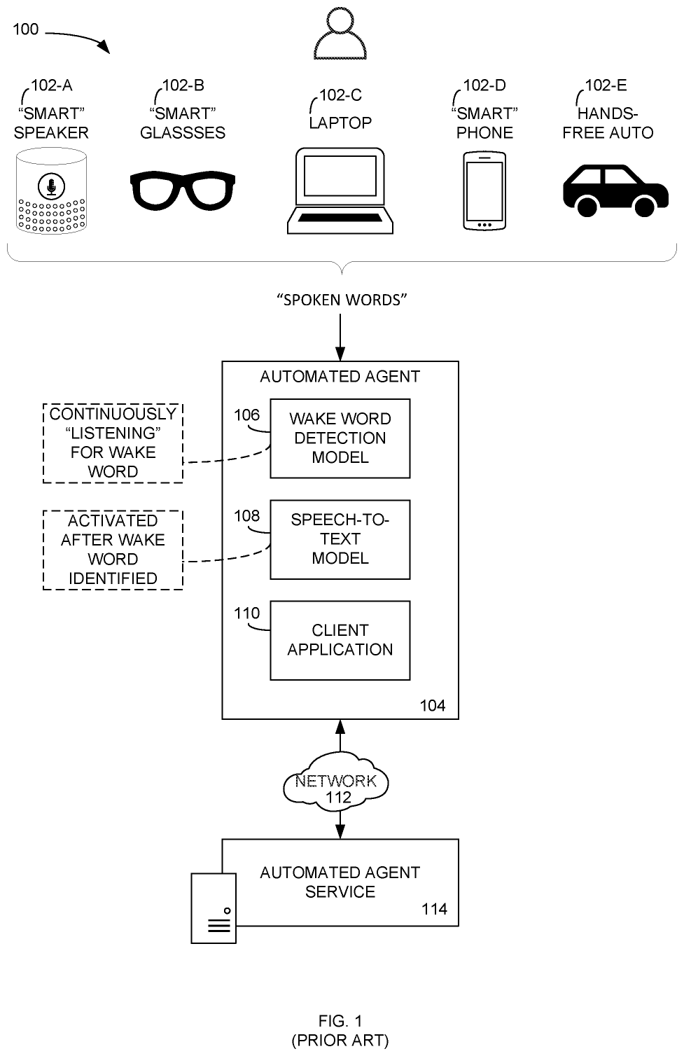

FIG. 1 illustrates a conventional automated agent 104, which is commonly integrated into various computing devices such as smart speakers 102-A, smart glasses 102-B, laptops 102-C, smartphones 102-D, and hands-free automotive systems 102-E, amongst others. With conventional automated agents 104, the computing device on which the software-based automated agent 104 is executing is equipped with an “always on” wake word detection model 106 that is in a continuous state of passive listening, specifically for a predetermined word or phrase, commonly referred to as a “wake word” or “wake phrase.” By way of example, some common automated agents use as wake words, “Alexa,” or “Hey Siri,” or other similar words or phrase triggers. The wake word detection model 106 serves as a gatekeeper, ensuring that the automated agent 104 remains dormant until the specific wake word is detected in the ambient audio that is captured by the microphone of the device executing the automated agent 104.

Once the wake word is recognized by the wake word detection model 106, the automated agent 104 begins actively capturing and processing the ambient audio via an automated speech recognition (ASR) model, or speech-to-text model 108. This model 108 is responsible for converting the subsequent spoken words into text, which can then be further processed or interpreted by the client application 110, to understand and execute user commands. The client application 110 may optionally communicate with a server-based automated agent service 114 over a network 112 to perform requested actions or retrieve information as directed or otherwise influenced by the user's spoken commands.

The conventional use of a wake word to expressly invoke an automated agent presents several technical problems. Firstly, the requirement for a wake word can disrupt the natural flow of conversation, as users must remember and use specific phrases to interact with their devices. This can lead to a less intuitive user experience, especially for new or infrequent users who may not recall the exact wake words or phrases. Secondly, the wake word approach can lead to false activations when the wake word detection model 106 mistakenly identifies similar-sounding words or phrases as the wake word, resulting in unintended recording and processing of audio. Finally, in noisy environments or during overlapping conversations, the wake word detection model 106 may fail to detect the wake word accurately, leading to user frustration when the automated agent does not activate as expected. Conversely, background conversations that inadvertently contain the wake word can trigger the automated agent 104 unintentionally, causing interruptions and potential privacy breaches.

Examples of various embodiments of the present invention, as described herein, provide a significant advancement in the field of AI-based conversational interfaces by introducing a technique that leverages generative language models, such as LLMs, to continuously analyze spoken words detected in ambient audio for user intent without the need for a specific wake word. Consistent with some examples, an AI-based automated agent comprises an Automatic Speech Recognition (ASR) model or speech-to-text model that captures spoken words and converts them into text. The converted text, representing the spoken words, is then processed by a prompt generator that formulates structured prompts for processing as input by an LLM. The LLM, which in some instances may be fine-tuned for a specific domain served by the automated agent, interprets these prompts to infer whether the spoken words are ambient conversation, or intended for the automated agent. In addition, consistent with some examples, the LLM is instructed to formulate output that specifically indicates the intent of the user, and is formatted in a structured manner, for example, as a JavaScript Object Notation (JSON) object.

In some examples, the structured prompts include not only the converted text, but in some instances, also contextual information that allows the LLM to discern the user's intent with greater accuracy. This approach enables the automated agent to understand and respond to user commands in a more natural and conversational manner. By eliminating the need for wake words, the AI-based automated agent allows for a seamless integration of the automated agent into the user's conversation, enhancing the overall user experience.

One of the technical advantages of the claimed invention is the reduction of false activations, a common issue with wake word detection models. Since the automated agent does not rely on a specific wake word or trigger phrase, the likelihood of the automated agent mistakenly activating in response to similar-sounding words or background noise is significantly decreased. This leads to a more reliable and user-friendly interaction, as the automated agent only responds when the user's intent is clearly directed towards it.

Another advantage is the automated agent's improved ability to handle noisy environments and overlapping conversations more effectively. The ASR or speech-to-text model and the LLM work in tandem to filter out irrelevant ambient noise and conversation and focus on the user's speech, thereby improving the accuracy of intent detection even in challenging audio conditions. This ensures that the automated agent remains responsive and accurate, providing users with confidence that their commands will be understood and acted upon correctly.

An additional advantage of the AI-based automated agent as descried herein is the LLM's capability to correct inaccuracies in the text generated by the ASR or speech-to-text model. For example, in instances where the ASR or speech-to-text model may misinterpret spoken words due to various factors such as speech clarity, accent, or background noise, the LLM can rectify these errors. The LLM analyzes a series of prompts within the context of the entire conversation history, which it maintains in its context window. This comprehensive view allows the LLM to identify inconsistencies or potential errors in the transcribed text.

For example, if the ASR model transcribes the phrase “I need a cab” as “I need a cap” due to background noise or speech ambiguity, the LLM can use the surrounding conversational context to recognize that the user's intent is more likely related to transportation rather than headwear. Drawing upon its extensive language understanding and the conversation history, the LLM can infer that “cab” is the correct word and adjust the transcribed text accordingly. This correction not only influences the determination regarding the user's intent, but the correction is also reflected in the structured output of the LLM, ensuring that the automated agent accurately captures the user's actual intent. This self- correcting mechanism of the LLM not only enhances the accuracy of user intent inference but also reduces the need for users to repeat themselves or make manual corrections, thereby streamlining the interaction process. By providing a more accurate representation of the user's spoken words, the system ensures that the automated agent's responses and actions are more aligned with the user's actual requests, further enhancing the overall user experience. Other aspects and advantages of the various embodiments of the invention are described below in connection with the description of the several figures that follow,

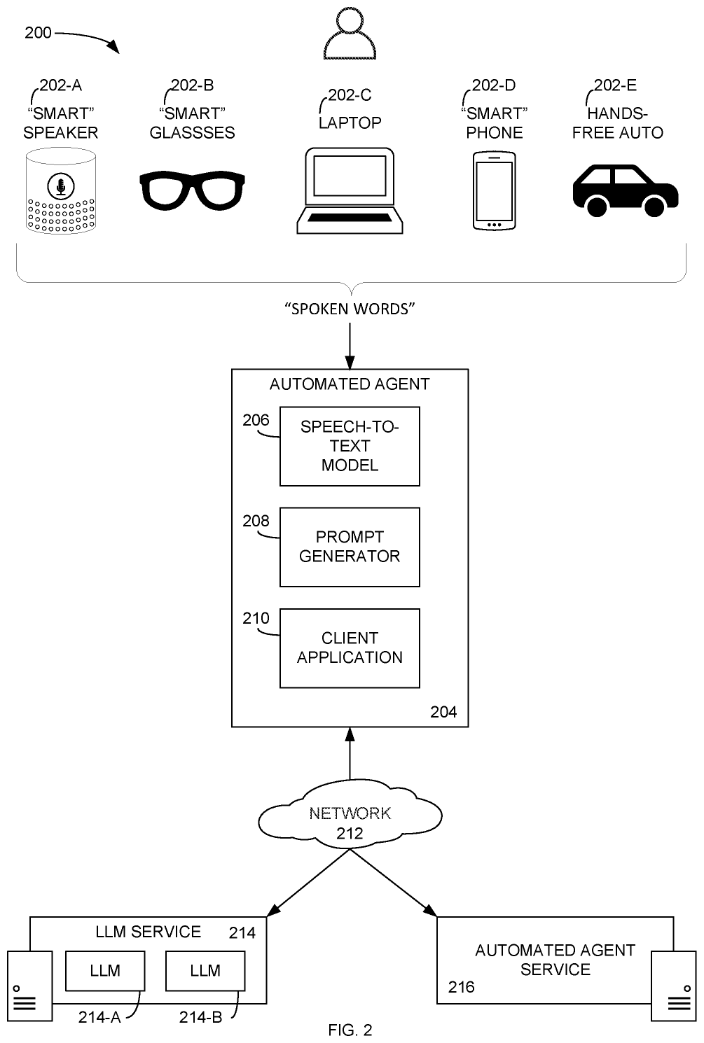

FIG. 2 is a diagram illustrating an example of an automated agent 204, consistent with some embodiments of the invention, which leverages the combination of an automatic speech recognition (ASR) model or speech-to-text model 206 and an LLM (e.g., 214-A or 214-B) to infer the intent of a user in interacting with the automated agent 204, based on captured spoken words, according to some examples. The automated agent 204 depicted in FIG. 2 has been designed to provide a more natural and intuitive user experience, as compared with the conventional system illustrated in FIG. 1. Specifically, unlike conventional automated agents that rely on wake words, the automated agent depicted in FIG. 2 does not rely on a wake word detection model to initiate or invoke interaction by a user. Instead, the automated agent 204 employs an ASR model or a speech-to-text model 206 that continuously processes captured ambient audio to convert spoken words within the ambient audio into text, without the need for a specific wake word or trigger phrase.

In some examples, the speech-to-text model 206 has or uses pause detection logic, which allows for identifying natural breakpoints in the user's speech. This pause detection logic operates by analyzing the audio stream for periods of silence that exceed a predefined threshold, which are indicative of the end of a phrase or sentence. The duration of these silences is carefully calibrated to differentiate between natural pauses that occur during speech, such as those for breath or thought, and the conclusion of a statement or command, By detecting these pauses, the automated agent can segment the continuous stream of speech into coherent and discrete textual units. This allows the automated agent to discern when a user has finished a statement or a command, thereby segmenting the continuous stream of speech into coherent and discrete textual units. This segmentation is helpful in subsequent processing stages, as it helps in maintaining the natural flow of conversation and ensures that the context of the user's speech is preserved.

The pause detection logic may utilize various acoustic signals and linguistic cues to enhance its accuracy. For instance, it may analyze the length of silence, the inflection at the end of words, and the probability of a pause based on the syntactic structure of the sentence being spoken. Additionally, the logic can be trained to recognize filler sounds often used by speakers, such as “uh” or “um,” which are not typically indicative of the end of a statement. By incorporating these sophisticated methods, the pause detection logic ensures that the speech-to-text model of the automated agent can maintain the natural flow of conversation, accurately reflecting the user's intent and preserving the context necessary for the LLM to generate a relevant and precise response.

Once the spoken words are converted into text by the speech-to-text model 206, the prompt generator 208 creates a structured prompt that includes at least two key components: the instruction portion and the context. The instruction portion is crafted to direct the LLM to analyze the provided text and determine whether it represents a command or request intended for the automated agent, or if it is merely ambient conversation not meant for the agent's response. The context, typically consisting of the converted text and potentially additional conversational history, provides the necessary background information for the LLM to make this determination.

Consistent with some examples, the ASR model or speech-to-text model 206 includes advanced voice recognition capabilities to differentiate and attribute spoken words to the correct individual, which is particularly advantageous in environments where multiple speakers are present. This process, known as speaker diarization, involves analyzing various characteristics of the speakers' voices to identify and segregate the speech segments corresponding to each person.

The speech-to-text model 208 may employ machine learning algorithms that are trained on a diverse dataset of voice samples to recognize distinct vocal features such as pitch, tone, speech cadence, and accent. These vocal features are unique to each individual, much like a vocal fingerprint, and allow the speech-to-text model 208 to create a profile for each speaker. During a conversation, the model 208 continuously compares incoming audio against these established profiles to determine the likelihood that a particular segment of speech belongs to a specific speaker.

Furthermore, the ASR model or speech-to-text model 208 can utilize spatial information when the computing device has multiple microphones. By assessing the directionality of the sound and the time difference of arrival of the spoken words to the different microphones, the system can infer the position of the speakers relative to the device. This spatial analysis enhances the device's ability to attribute speech segments to the correct individual, especially in situations where the vocal characteristics of two speakers may be similar.

The combination of vocal feature recognition and spatial analysis allows the speech-to-text model 208 to construct a more accurate transcription of multi-person conversations. Each speaker's words are transcribed separately, with speaker labels attached to the corresponding text segments. This precise attribution is beneficial for the subsequent processing stages, as it allows the LLM to accurately infer the context of the conversation and determine whether the spoken words are intended for the automated agent. By maintaining the integrity of the dialogue structure, the ASR model or speech-to-text model 208 ensures that the automated agent can interact with users in a conversational manner that mirrors natural human-to-human communication.

Consistent with some examples, the prompt generator 208 employs various strategies to generate the prompts that are provided as input to the LLM. One approach is the use of template-based prompts, where a portion of the prompt is predefined and includes static elements that outline the general structure and objectives of the prompt. These static elements are consistent across different instances and provide a structure that ensures the LLM receives the necessary instruction in a familiar format. Dynamic elements are then inserted into this prompt template in real-time, based on the specific context of the user's current interaction. These dynamic elements may include the latest segment of converted text from the user's speech, relevant metadata such as the time of the interaction, the location of the user, or any other pertinent information that could influence the LLM's analysis.

In addition to template-based generation, the prompt generator 208 may also utilize more sophisticated methods such as conditional logic, where the content of the prompt is further tailored based on certain conditions or triggers identified in the user's speech. Alternatively, machine learning algorithms can be employed to learn from past interactions and progressively refine the structure and content of the prompts over time, making them more effective in eliciting the desired output from the LLM. Another method could involve heuristic approaches where the prompt generator selects or generates prompts based on heuristic rules or patterns recognized in the user's speech, aiming to optimize the LLM's performance for each unique interaction. These various methods can be used in isolation or combined to create a robust and adaptive prompt generator 504 that enhances the LLM's ability to discern and respond to user intent accurately.

Consistent with some examples, the LLMs, such as 214-A and 214-B, are accessed over a network 212 and through an external LLM service 214. This LLM service 214 provides LLMs having function calling capabilities that enable the LLMs to process structured prompts effectively. To enhance the LLMs' ability to discern user intent, consistent with some examples, the LLMs are fine-tuned using a system prompt that incorporates multi-shot fine-tuning examples. These examples demonstrate a range of situations, helping the LLM to differentiate between commands intended for the automated agent and mere background conversation. For example, a system prompt used for fine-tuning might include various instances that clearly delineate user intent as either being directed at the automated agent or as part of ambient noise. For instance, a system prompt with fine-tuning examples could be as follows:
System prompt: “You will recieve a stream of text, your task is to determine if someone is talking to you, or if it's ambient conversation, and then extract the user's intent. Do not answer their question and always respond in valid JSON format.”
Example input: “The weather is nice today, but how will it be tomorrow?”
Example output: [symbol]
Example input: “I had a long day at work. Oh, and I need to set an alarm for 6 AM.”
Example output: [symbol]
Example input: “I can't believe how well the team played last night!”
Example output: {“intent”: “NONE”}

These examples demonstrate the LLM's ability to accurately extract and act upon user intent, distinguishing between direct interactions and background conversation. By leveraging these advanced LLM capabilities, the automated agent 204 illustrated in FIG. 2 offers a significant improvement over traditional wake word-based systems, providing a more seamless and engaging user experience.

While FIG. 2 illustrates the LLMs as being hosted by an external service provider, alternative embodiments of the invention allow for the LLMs to be executed directly on the device of the automated agent 204. In such configurations, the device would contain the necessary computational resources to execute the LLMs locally, thereby potentially reducing latency and reliance on external service connectivity for processing user commands and queries.

The automated agent 204 as depicted in FIG. 2 is versatile and can be integrated into a wide array of devices, each designed to cater to the unique needs of different environments and user interactions. These devices range from smart speakers 202-A that can be used in homes and offices for tasks such as controlling smart home devices or providing information, to smart glasses 202-B that offer hands-free assistance and augmented reality experiences. Laptops 202-C and smartphones 202-D are ubiquitous devices that benefit from the integration of automated agents, enhancing productivity and providing on-the-go assistance. Additionally, hands-free automotive systems 202-E can significantly improve the driving experience by allowing drivers to focus on the road while issuing voice commands for navigation, entertainment, or some vehicle controls.

Automated agents can be general-purpose, designed to handle a wide variety of tasks and queries from users. These agents are equipped to leverage LLMs that have a broad understanding of language and can process general instructions across multiple domains. On the other hand, domain-specific automated agents are tailored to provide specialized assistance within a particular field or context. For example, an automated agent integrated into a medical device may be fine-tuned to understand and process healthcare-related queries, while one in a financial application may be specialized in handling banking and investment questions.

For domain-specific automated agents, the LLM's fine-tuning process helps to ensure high accuracy and relevance in its responses. The system prompt used to fine-tune the LLM includes domain-specific examples that guide the LLM in recognizing and interpreting the intent behind user inputs within that particular domain. Each example provided to the LLM consists of an input, such as a stream of text that might be captured from a user's speech, and a corresponding desired output, which could be the user's intent or an indication that the input does not represent an intent directed towards the automated agent.

For instance, in a domain-specific system designed for culinary assistance, the system prompt might include examples like:
System prompt: “Identify if the following text is a culinary-related request for the automated agent.”
Example input: “I'm wondering how many teaspoons are in a tablespoon.”
Example output:

[symbol]

Alternatively, for an input unrelated to the culinary domain:
Example input: “I'm going to wear my new shoes tonight.”
Example output:

[symbol]

These fine-tuning examples enable the LLM to develop a nuanced understanding of the domain-specific language and user requests, allowing the automated agent 204 to provide targeted and accurate assistance. By incorporating such domain-specific knowledge, the automated agent 204 becomes a powerful tool, enhancing user experience and efficiency within its specialized area of operation.

Upon receiving the structured output from the LLM, the client application 210 can take a multitude of specific actions based on the inferred intent of the user. The nature of these actions is highly dependent on the context of the request and the capabilities of the device on which the automated agent is operating. For instance, if the structured output from the LLM 214-A indicates an intent to obtain weather information, the client application 210 may direct a request to an external weather service (e.g., automated agent service 216) to retrieve the latest forecast information. This request would be formatted according to the specifications of the weather service's application programming interface (API), ensuring that the user's need for weather-related information is met with precise and timely data. It is also worth noting here that in some instances, based on the output received from the LLM (e.g., 2140A or 214B) and the specific intent of the user to invoke the automated agent, a subsequent LLM prompt may be generated and communicated to another LLM, different from the LLM used in inferring the intent of the user. This subsequent prompt enables the second LLM to process the user's query in a specialized context, such as when the user's intent pertains to a domain-specific query like requesting financial news updates, where an LLM that is specifically fine-tuned to provide financial information would be best suited to respond.

By way of example, if the structured output indicates that the user intends to schedule a meeting, a client application 210 may interact with a user's calendar system to create a new event. If the intent is to play a particular song or genre of music, the client application 210 may interface with a multimedia system to begin playback. In the case of a smart home device, if the user's intent is to adjust the temperature, the client application 210 could send a command to the home's thermostat system.

Here are several examples of actions that the client application 210 might take:
For a smart speaker 202-A, the action could be to provide a weather update or to set a timer for cooking based on the user's request.
In the case of smart glasses 202-B, the action might involve displaying navigation directions in the user's field of view or translating a sign or menu from another language.
On a laptop 202-C, the action could be to open a document or send an email as per the user's spoken instructions.
For a smartphone 202-D, the client application might initiate a call, send a text message, or open a mobile application in response to the user's command.
Within a hands-free automotive system 202-E, the action could be to find the nearest gas station, change the audio track, or adjust the cabin lighting based on the driver's request.

Additionally, the client application 210 may use the output received from the LLM 214-A or 214-B to make a subsequent call or query to a remote, server-based automated agent service 216. This is particularly useful when the request requires additional processing power, access to large datasets, or specialized knowledge that is not locally available on the computing device of the automated agent 204. For instance:
The client application might query a remote service for real-time traffic updates or public transit schedules if the user's intent involves travel planning.
It could access a server-based service to make restaurant reservations or order food delivery when the user expresses the intent to dine out.
The client application may reach out to a financial service to check account balances or initiate transactions if the user's request pertains to banking activities.

These examples illustrate the versatility of the client application 210 in responding to the structured output from the LLM, enabling a wide range of actions and interactions that cater to the user's needs and enhance the overall experience with the automated agent 204.

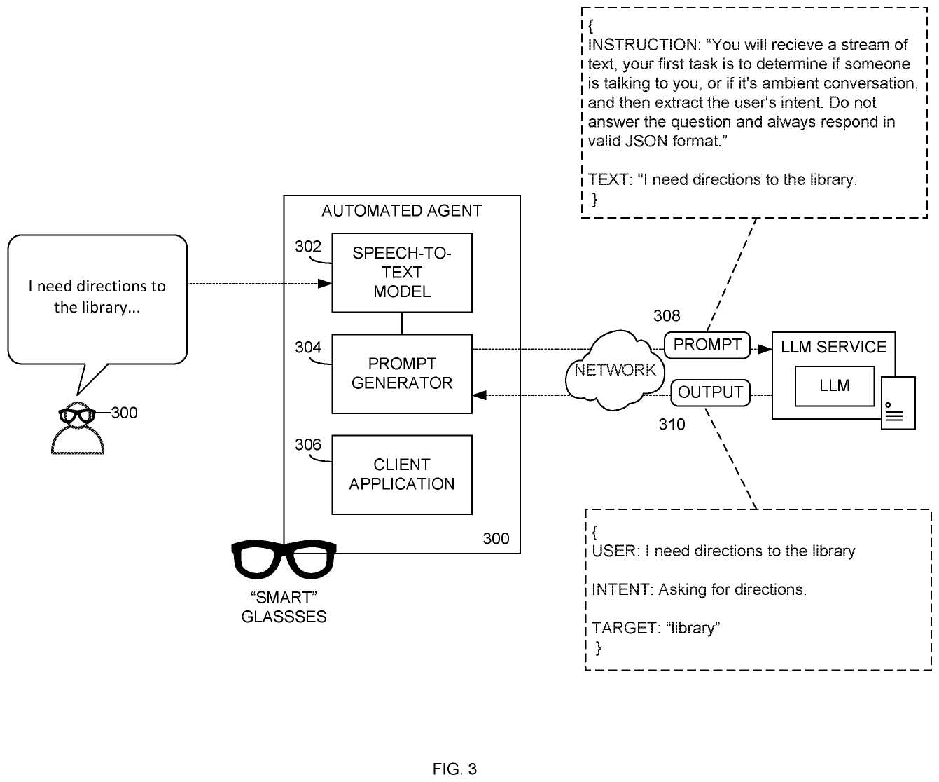

FIG. 3 is a diagram illustrating an example of the interaction between a user of an automated agent, implemented with smart glasses 300, leveraging an LLM to infer the intent of the user, based on words spoken by the user, according to some examples. In this example, the user interacts with a device equipped with an automated agent, such as “smart” glasses 300, which are designed to capture spoken words through an integrated microphone. The spoken words are then processed by a speech-to-text model 302, which converts the audio input into a textual representation. This text is subsequently passed to a prompt generator 304, which formulates a structured prompt that encapsulates the user's spoken words along with an instruction for the LLM.

The structured prompt 308 is then transmitted to an LLM service over a network. An LLM hosted by the LLM service analyzes the text and determines the user's intent. The LLM does so by processing the instruction provided in the prompt 308, which directs the LLM to differentiate between commands intended for the automated agent and ambient conversation. The LLM processes the prompt 308 to interpret the text and generate a structured output 310 that reflects the user's intent.

In the illustrated example within FIG. 3, the user's spoken words are “I need directions to the library.” The prompt generator 304 creates a structured prompt 308 that includes these words and transmits it to the LLM service. The LLM, upon receiving the prompt 308, evaluates the text and recognizes that the user is requesting directions—a task that is within the domain of the automated agent's capabilities. The LLM then generates a structured output in the form of a JavaScript Object Notation (JSON) object, which includes fields such as “intent” and “target.” The “intent” field is populated with the user's request, “Asking for directions,” and the “target” field specifies the destination mentioned by the user, “library.”

The client application 306 on the user's device receives this structured output and takes appropriate action. In this case, the client application 306 may interact with a mapping application or service to provide the user with the requested directions to the library. This interaction demonstrates the seamless process of intent inference using an LLM, which enables the automated agent 300 to provide relevant and timely assistance to the user.

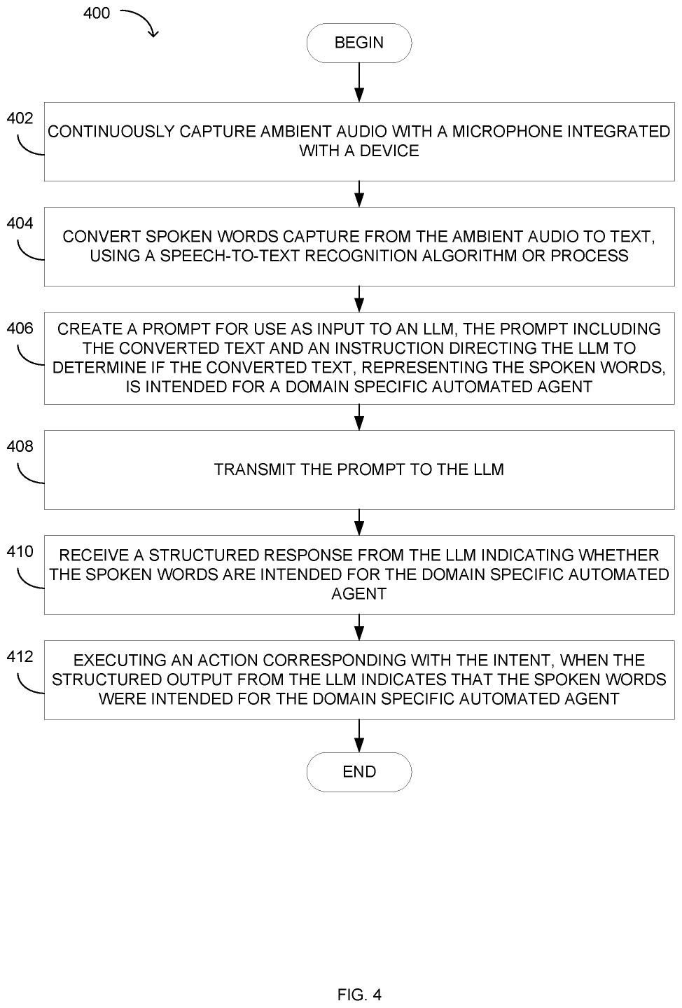

FIG. 4 is a flow diagram illustrating the operational steps involved in processing spoken language to determine user intent for interaction with a domain-specific automated agent, according to some examples. The process begins with the continuous capture of ambient audio through a microphone integrated with a device 402. This device could be any of the aforementioned examples, such as smart glasses or a smartphone. The ambient audio is expected to contain spoken words from the user, which may or may not be directed towards the automated agent.

Once the audio is captured, the spoken words are converted into text using a speech-to-text recognition algorithm or process 404. This conversion transforms the user's spoken language into a format that can be processed by the LLM. The speech-to-text model may include advanced features such as noise cancellation and language model adaptation to improve accuracy.

Following the conversion, an LLM prompt is created for use as input to an LLM 406. This prompt includes the converted text and an instruction directing the LLM to determine if the text represents a command or request intended for the domain-specific automated agent or if it is part of the ambient conversation. The prompt may also include additional context, such as the user's previous interactions or commands, to assist the LLM in making a more informed decision.

The prompt is then transmitted to the LLM 408, which resides on a server that could be accessed over a network. The LLM analyzes the prompt and generates a structured output as a response. This response indicates whether the spoken words are intended for the domain-specific automated agent, and if so, the intent of the user.

Upon receiving the structured output from the LLM, the automate agent executes an action corresponding to the intent 412. If the structured output indicates that the spoken words were intended for the domain-specific automated agent, a client application or the automated agent itself, will proceed with the appropriate response or action. This could involve querying a remote server-based automated agent service for additional information or performing a local action on the device itself.

The end of the flow diagram signifies the completion of the process. The structured and systematic approach outlined in FIG. 4 ensures that the user's intent is accurately captured and responded to, thereby enhancing the user experience with the automated agent.

In the various figures presented, the LLM is depicted and described as being hosted by a remote LLM service, which is accessible to the automated agent via a network. This configuration allows for the leveraging of powerful cloud-based computing resources to process and analyze the spoken language inputs, providing the necessary computational power and data access that may not be available locally on the user's device. However, it is important to note that this is not the only possible configuration. In other instances, depending on the capabilities of the device at which the automated agent is executing, the LLM could be hosted locally on the device itself. This on-device hosting can offer advantages such as reduced latency, enhanced privacy, and functionality without the need for a continuous network connection. Devices with sufficient processing power and storage, such as high-end smartphones, laptops, or dedicated AI hardware, could support an on-device LLM, enabling the automated agent to process inputs and infer user intent directly on the device. This flexibility in the hosting of the LLM allows for a range of implementations tailored to the specific requirements and constraints of different devices and use cases.

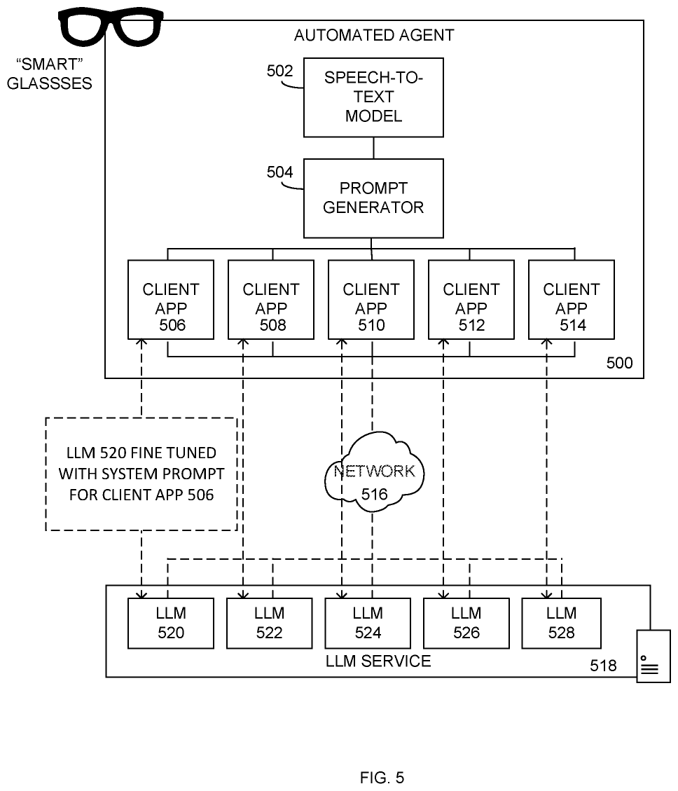

FIG. 5 is a schematic representation illustrating the various implementations of an automated agent, which can either be a general-purpose agent serving on dedicated devices such as smart speakers, phones, laptops, glasses, etc., or a domain-specific agent tailored to provide information and perform tasks within a particular domain, often associated with a specific application. The diagram shows a user interacting with “smart” glasses 500, which serve as the client device. The client applications (506, 508, 510, 512, 514) represent different domain-specific applications that the user may engage with via the smart glasses 500. Each application is associated with its own LLM (520, 522, 524, 526, 528), which is fine-tuned to handle queries and commands relevant to its respective domain. The fine-tuning process for each LLM involves multi-shot examples with a system prompt, which trains the LLM to recognize and process domain-specific user intents accurately.

For instance, if the user is utilizing a map application 506 on the smart glasses, the prompt generator 504 will direct the user's spoken words to an LLM 520 that is specifically fine-tuned for geographic and navigation-related queries. This LLM 520 would have been trained with examples such as requesting directions, inquiring about traffic conditions, or asking for the location of nearby points of interest.

Similarly, if the user opens a calendar application 508, the spoken commands related to scheduling, such as setting up meetings, reminders, or checking availability, would be directed to a different LLM 522 that specializes in handling scheduling and time management tasks, Another example could be a weather application 510, where the user's inquiries about temperature, forecasts, or weather conditions would prompt the generator 504 to select an LLM 524 that has been trained or fine-tuned with meteorological data and can provide up-to-date weather information.

In each case, the LLM associated with the active client application processes the structured prompt, which includes the user's spoken words and specific instructions, to infer the user's intent. The LLM then generates a structured output that the client application uses to provide a response or perform an action relevant to the user's request. This architecture allows for a seamless and intuitive interaction between the user and the automated agent, with the agent's responses being contextually appropriate to the application in use.

The structured JSON object provided as output by the LLM can be tailored to include various structured data fields, which are contingent upon the specific domain of the automated agent and the instructions delineated in the prompt. These fields are designed to encapsulate all the necessary information that the client application may require to perform the intended action. For instance, in a healthcare domain, the JSON object might include fields for symptoms, medication requests, or appointment scheduling. Conversely, in a home automation domain, the fields might relate to device control commands, such as adjusting the thermostat or turning lights on and off. The flexibility of the JSON format allows for the inclusion of a wide range of data types and structures, making it a versatile medium for communication between the LLM and the client application.

In the various examples and figures provided, the LLM prompt is typically described as a single structured prompt designed to elicit a single output from the LLM. This output is structured to identify whether the spoken words are intended for an automated agent and, if so, to clarify the intent of those spoken words. Consequently, the structured output will generally include at least two data fields: one indicating the presence of intent directed towards the automated agent and another detailing the specific intent of the spoken words.

However, in some instances, particularly for a client application within a specific domain, the prompt may be crafted to generate a more complex structured output that includes additional data fields. For example, in the domain of a map application or service, the LLM may produce structured output that not only indicates whether the spoken words were intended for the agent and the intent of the spoken words but also provides additional data such as a specific location or destination mentioned by the user.

Consider a scenario where a user says, “How do I get to the nearest gas station?” while using a map application. In this case, the prompt sent to the LLM would be structured to extract multiple pieces of information from this query. The LLM's output might include a data field confirming that the query is indeed intended for the map application (“intent_detected”: true), a second field identifying the user's intent (“intent”: “request_directions”), and a third field specifying the location-related aspect of the intent (“location”: “nearest gas station”). This structured output enables the map application to understand that the user is asking for directions and is specifically interested in locating the nearest gas station, allowing the application to respond accurately and efficiently by providing the requested directions.

In some cases, the process may involve multiple prompts to accomplish distinct tasks. For example, an initial prompt might be utilized solely to determine if the spoken words were intended for the automated agent. Subsequently, a second prompt could be employed to pinpoint the specific intent of the user. This second stage may involve generating additional data that is pertinent to the user's intent, the overarching task, the domain, the client application, and so on. This bifurcated approach allows for a more granular and precise extraction of information, where the first prompt acts as a filter for relevance, and the second prompt delves into the specifics of the user's request, tailoring the response to the particular needs and context of the interaction.

In the realm of domain-specific applications, the structured prompts provided to the LLM can be enriched with additional data that enhances the LLM's ability to accurately infer the user's intent. This supplementary data serves as contextual cues that inform the LLM's interpretation of the spoken words, leading to more precise and relevant responses from the automated agent.

For instance, in the context of an automobile, the prompt sent to the LLM may include not only the speech-to-text converted dialogue but also data indicative of the vehicle's current state. This could encompass the vehicle's location, whether it is in motion or stationary, and if it is moving, the speed at which it is traveling. Such information can be crucial in understanding the user's intent. For example, a request for nearby gas stations would imply different levels of urgency if the vehicle is stationary versus if it is moving at highway speeds, which might suggest the need for immediate assistance due to low fuel.

Similarly, in a smart home environment, the prompt may include data about the time of day, the status of various connected devices, or even the user's calendar information. If a user speaks about adjusting the temperature, the LLM, informed by the current indoor temperature and the user's typical preferences for that time of day, can make a more informed decision about the user's intent.

In healthcare applications, the prompt could be augmented with data such as the user's medical history or current biometric data. This would allow the LLM to interpret a statement about feeling unwell in the context of the user's known health conditions, potentially recognizing an emergent situation that requires immediate attention.

By tailoring the additional data included in the prompts to the specific domain of the application, the LLM can leverage this context to deliver responses that are not only accurate but also aligned with the user's immediate needs and the situational nuances of the environment. This approach underscores the adaptability and potential of LLMs to provide sophisticated, context-aware interactions in a wide array of specialized domains.

### Machine Architecture

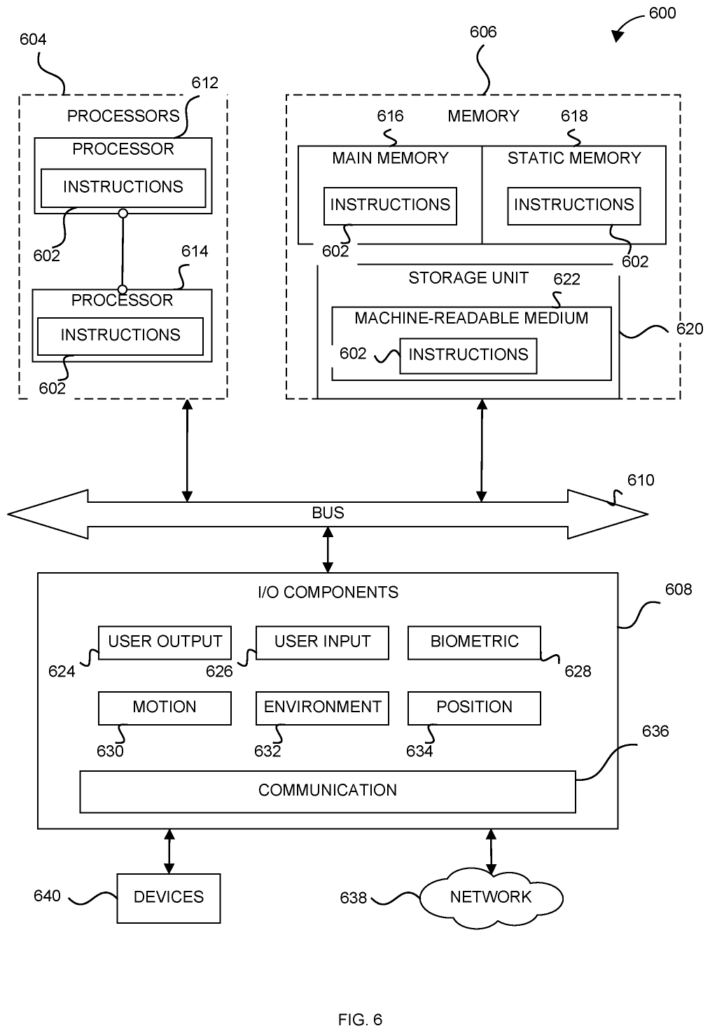

FIG. 6 is a diagrammatic representation of the machine 600 within which instructions 602 (e.g., software, a program, an application, an applet, an app, or other executable code) for causing the machine 600 to perform any one or more of the methodologies discussed herein may be executed. For example, the instructions 602 may cause the machine 600 to execute any one or more of the methods described herein. The instructions 602 transform the general, non-programmed machine 600 into a particular machine 600 programmed to carry out the described and illustrated functions in the manner described. The machine 600 may operate as a standalone device or may be coupled (e.g., networked) to other machines. In a networked deployment, the machine 600 may operate in the capacity of a server machine or a client machine in a server-client network environment, or as a peer machine in a peer-to-peer (or distributed) network environment. The machine 600 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smart phone, a mobile device, a wearable device (e.g., a smartwatch or smart glasses), a wearable augmented/virtual/mixed reality device, a smart home device (e.g., a smart appliance), other smart devices, a web appliance, a network router, a network switch, a network bridge, or any machine capable of executing the instructions 602, sequentially or otherwise, that specify actions to be taken by the machine 600. Further, while a single machine 600 is illustrated, the term “machine” shall also be taken to include a collection of machines that individually or jointly execute the instructions 602 to perform any one or more of the methodologies discussed herein. The machine 600, for example, may comprise a user system or any one of multiple server devices forming part of an interaction server system for posting and sharing messages and other content. In some examples, the machine 600 may also comprise both client and server systems, with certain operations of a particular method or algorithm being performed on the server-side and with certain operations of the particular method or algorithm being performed on the client-side.

The machine 600 may include processors 604, memory 606, and input/output I/O components 608, which may be configured to communicate with each other via a bus 610. In an example, the processors 604 (e.g., a Central Processing Unit (CPU), a Reduced Instruction Set Computing (RISC) Processor, a Complex Instruction Set Computing (CISC) Processor, a Graphics Processing Unit (GPU), a Digital Signal Processor (DSP), an Application Specific Integrated Circuit (ASIC), a Radio-Frequency Integrated Circuit (RFIC), another processor, or any suitable combination thereof) may include, for example, a processor 612 and a processor 614 that execute the instructions 602. The term “processor” is intended to include multi-core processors that may comprise two or more independent processors (sometimes referred to as “cores”) that may execute instructions contemporaneously. Although FIG. 6 shows multiple processors 604, the machine 600 may include a single processor with a single-core, a single processor with multiple cores (e.g., a multi-core processor), multiple processors with a single core, multiple processors with multiples cores, or any combination thereof.

The memory 606 includes a main memory 616, a static memory 618, and a storage unit 620, both accessible to the processors 604 via the bus 610. The main memory 606, the static memory 618, and storage unit 620 store the instructions 602 embodying any one or more of the methodologies or functions described herein. The instructions 602 may also reside, completely or partially, within the main memory 616, within the static memory 618, within machine-readable medium 622 within the storage unit 620, within at least one of the processors 604 (e.g., within the processor's cache memory), or any suitable combination thereof, during execution thereof by the machine 600.

The I/O components 608 may include a wide variety of components to receive input, provide output, produce output, transmit information, exchange information, capture measurements, and so on. The specific I/O components 608 that are included in a particular machine will depend on the type of machine. For example, portable machines such as mobile phones may include a touch input device or other such input mechanisms, while a headless server machine will likely not include such a touch input device. It will be appreciated that the I/O components 608 may include many other components that are not shown in FIG. 6. In various examples, the I/O components 608 may include user output components 624 and user input components 626. The user output components 624 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The user input components 626 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and force of touches or touch gestures, or other tactile input components), audio input components (e.g., a microphone), and the like.

In further examples, the I/O components 608 may include biometric components 628, motion components 630, environmental components 632, or position components 634, among a wide array of other components. For example, the biometric components 628 include components to detect expressions (e.g., hand expressions, facial expressions, vocal expressions, body gestures, or eye-tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The biometric components may include a brain-machine interface (BMI) system that allows communication between the brain and an external device or machine. This may be achieved by recording brain activity data, translating this data into a format that can be understood by a computer, and then using the resulting signals to control the device or machine.

Example types of BMI technologies, including:
Electroencephalography (EEG) based BMIs, which record electrical activity in the brain using electrodes placed on the scalp.
Invasive BMIs, which used electrodes that are surgically implanted into the brain.
Optogenetics BMIs, which use light to control the activity of specific nerve cells in the brain.

Any biometric data collected by the biometric components is captured and stored only with user approval and deleted on user request. Further, such biometric data may be used for very limited purposes, such as identification verification. To ensure limited and authorized use of biometric information and other personally identifiable information (PII), access to this data is restricted to authorized personnel only, if at all. Any use of biometric data may strictly be limited to identification verification purposes, and the data is not shared or sold to any third party without the explicit consent of the user. In addition, appropriate technical and organizational measures are implemented to ensure the security and confidentiality of this sensitive information.

The motion components 630 include acceleration sensor components (e.g., accelerometer), gravitation sensor components, rotation sensor components (e.g., gyroscope).

The environmental components 632 include, for example, one or cameras (with still image/photograph and video capabilities), illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment.

With respect to cameras, a user system may have a camera system comprising, for example, front cameras on a front surface of the user system and rear cameras on a rear surface of the user system. The front cameras may, for example, be used to capture still images and video of a user of the user system (e.g., “selfies”), which may then be augmented with augmentation data (e.g., filters) described above. The rear cameras may, for example, be used to capture still images and videos in a more traditional camera mode, with these images similarly being augmented with augmentation data. In addition to front and rear cameras, the user system may also include a 360° camera for capturing 360° photographs and videos.

Further, the camera system of the user system may include dual rear cameras (e.g., a primary camera as well as a depth-sensing camera), or even triple, quad or penta rear camera configurations on the front and rear sides of the user system. These multiple cameras systems may include a wide camera, an ultra-wide camera, a telephoto camera, a macro camera, and a depth sensor, for example.

The position components 634 include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 608 further include communication components 636 operable to couple the machine 600 to a network 638 or devices 640 via respective coupling or connections. For example, the communication components 636 may include a network interface component or another suitable device to interface with the network 638. In further examples, the communication components 636 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 640 may be another machine or any of a wide variety of peripheral devices (e.g., a peripheral device coupled via a USB).

Moreover, the communication components 636 may detect identifiers or include components operable to detect identifiers. For example, the communication components 636 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph™, MaxiCode, PDF417, Ultra Code, UCC RSS-2D bar code, and other optical codes), or acoustic detection components (e.g., microphones to identify tagged audio signals). In addition, a variety of information may be derived via the communication components 636, such as location via Internet Protocol (IP) geolocation, location via Wi-Fi® signal triangulation, location via detecting an NFC beacon signal that may indicate a particular location, and so forth. The various memories (e.g., main memory 616, static memory 618, and memory of the processors 604) and storage unit 620 may store one or more sets of instructions and data structures (e.g., software) embodying or used by any one or more of the methodologies or functions described herein. These instructions (e.g., the instructions 602), when executed by processors 604, cause various operations to implement the disclosed examples.

The instructions 602 may be transmitted or received over the network 638, using a transmission medium, via a network interface device (e.g., a network interface component included in the communication components 636) and using any one of several well-known transfer protocols (e.g., hypertext transfer protocol (HTTP)). Similarly, the instructions 602 may be transmitted or received using a transmission medium via a coupling (e.g., a peer-to-peer coupling) to the devices 640.

### Software Architecture

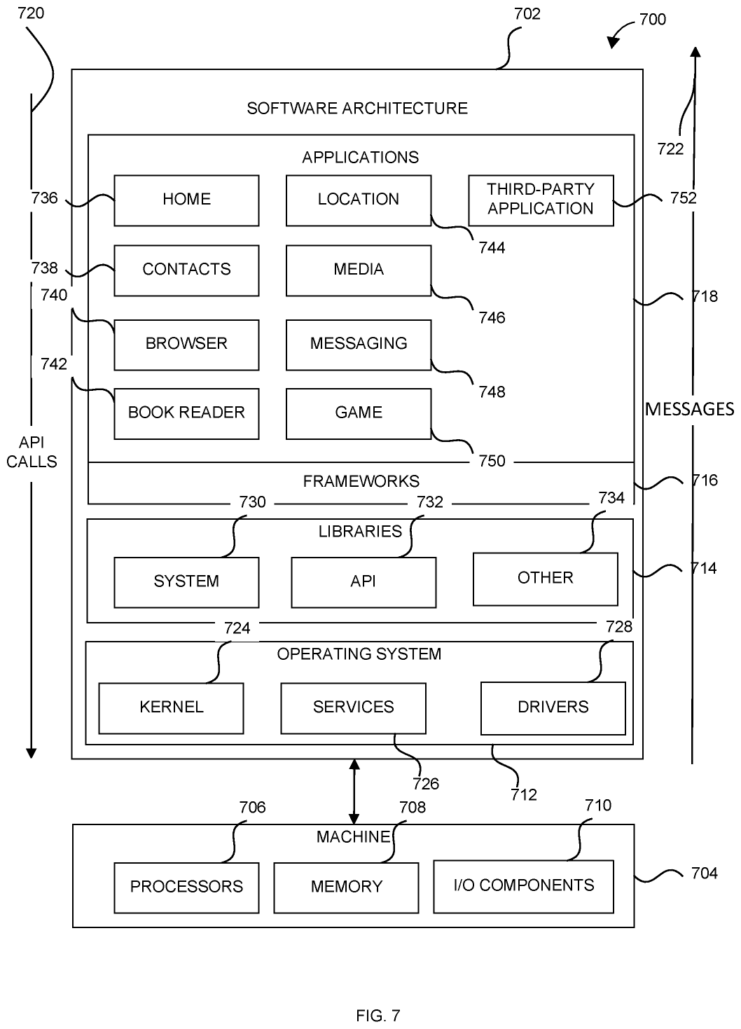

FIG. 7 is a block diagram 700 illustrating a software architecture 702, which can be installed on any one or more of the devices described herein. The software architecture 702 is supported by hardware such as a machine 704 that includes processors 706, memory 708, and I/O components 710. In this example, the software architecture 702 can be conceptualized as a stack of layers, where each layer provides a particular functionality. The software architecture 702 includes layers such as an operating system 712, libraries 714, frameworks 716, and applications 718. Operationally, the applications 718 invoke API calls 720 through the software stack and receive messages 722 in response to the API calls 720.

The operating system 712 manages hardware resources and provides common services. The operating system 712 includes, for example, a kernel 724, services 726, and drivers 728. The kernel 724 acts as an abstraction layer between the hardware and the other software layers. For example, the kernel 724 provides memory management, processor management (e.g., scheduling), component management, networking, and security settings, among other functionalities. The services 726 can provide other common services for the other software layers. The drivers 728 are responsible for controlling or interfacing with the underlying hardware. For instance, the drivers 728 can include display drivers, camera drivers, BLUETOOTH® or BLUETOOTH® Low Energy drivers, flash memory drivers, serial communication drivers (e.g., USB drivers), WI-FI® drivers, audio drivers, power management drivers, and so forth.

The libraries 714 provide a common low-level infrastructure used by the applications 718. The libraries 714 can include system libraries 730 (e.g., C standard library) that provide functions such as memory allocation functions, string manipulation functions, mathematic functions, and the like. In addition, the libraries 714 can include API libraries 732 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic content on a display), database libraries (e.g., SQLite to provide various relational database functions), web libraries (e.g., WebKit to provide web browsing functionality), and the like. The libraries 714 can also include a wide variety of other libraries 734 to provide many other APIs to the applications 718.

The frameworks 716 provide a common high-level infrastructure that is used by the applications 718. For example, the frameworks 716 provide various graphical user interface (GUI) functions, high-level resource management, and high-level location services. The frameworks 716 can provide a broad spectrum of other APIs that can be used by the applications 718, some of which may be specific to a particular operating system or platform.

In an example, the applications 718 may include a home application 736, a contacts application 738, a browser application 740, a book reader application 742, a location application 744, a media application 746, a messaging application 748, a game application 750, and a broad assortment of other applications such as a third-party application 752. The applications 718 are programs that execute functions defined in the programs. Various programming languages can be employed to create one or more of the applications 718, structured in a variety of manners, such as object-oriented programming languages (e.g., Objective-C, Java, or C++) or procedural programming languages (e.g., C or assembly language). In a specific example, the third-party application 752 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third-party application 752 can invoke the API calls 720 provided by the operating system 712 to facilitate functionalities described herein.

### EXAMPLES

Example 1 is a system for processing spoken language to determine user intent for interaction with an automated agent, the system comprising: at least one processor; at least one memory component storing instructions that, when executed by the at least one processor, cause the at least one processor to perform operations comprising: continuously monitoring ambient audio via a microphone integrated with a device; converting captured spoken words from the ambient audio into text using a speech-to-text conversion process; generating a structured prompt that includes, at least the converted text and an instruction for a Large Language Model (LLM), wherein the instruction is configured to request the LLM to infer whether the spoken words are intended for the automated agent; transmitting the structured prompt to the LLM; receiving, from the LLM, a structured output in a standardized format, wherein the structured output includes an inference result indicating whether the spoken words are intended for the automated agent and, if so, identifying the intent of the user; and executing an action by the automated agent based on the identified intent of the user when the inference result indicates that the spoken words are intended for the automated agent.

In Example 2, the subject matter of Example 1 includes, wherein the automated agent is a domain-specific automated agent and the operations further comprise providing a system prompt distinct from the structured prompt as input to the LLM, the system prompt providing multi-shot fine-tuning examples to the LLM for a domain of the domain-specific automated agent, each example comprising a sample of spoken words and a corresponding structured output that indicates either a specific intent or absence of intent.

In Example 3, the subject matter of Example 2 includes, wherein the operations further comprise providing a system prompt distinct from the structured prompt as input to the LLM, the system prompt including an instruction for the LLM to analyze a stream of text converted from spoken words to determine if the spoken words within the stream are directed towards the domain-specific automated agent or constitute ambient conversation, to extract the intent of the user from the spoken words intended for the domain-specific automated agent, and to generate a response in valid JavaScript Object Notation (JSON) format that indicates the extracted intent of the user without answering any questions posed within the stream of text.

In Example 4, the subject matter of Example 3 includes, wherein the structured output is in JSON format, and the structured output includes a field for the identified intent of the user that is populated when the inference result is positive.

In Example 5, the subject matter of Examples 1-4 includes, wherein the structured prompt further includes an instruction for the LLM to correct errors in the converted text using contextual information from previous interactions, and the operations further comprise receiving a corrected text from the LLM as part of the structured output before executing an action by the automated agent.

In Example 6, the subject matter of Examples 1-5 includes, wherein the automated agent is integrated into an augmented reality (AR) device, and the action executed by the automated agent includes displaying relevant information via an application executing within an AR environment of the AR device.

In Example 7, the subject matter of Examples 1-6 includes, wherein the speech-to-text conversion process includes a pause detection feature that identifies the end of a spoken sentence and triggers transmission of the structured prompt to the LLM.

In Example 8, the subject matter of Examples 1-7 includes, wherein the LLM is configured to utilize a function calling capability that ensures the structured output is provided in a standardized format, the function calling capability enabling the LLM to execute predefined functions within the structured prompt that correspond to specific tasks, including correction of transcription errors resulting from the conversion of the captured spoken words from the ambient audio into text using the speech-to-text conversion process, and the inference of user intent from the text corresponding with the captured spoken words.

In Example 9, the subject matter of Examples 1-8 includes, wherein the automated agent is integrated into an automobile's infotainment system, and the action executed by the automated agent includes receiving spoken commands related to vehicle control functions, such as adjusting climate settings, setting navigation destinations, or activating windshield wipers, and wherein the LLM is fine-tuned to recognize and process commands specific to automotive operations.

Example 10 is a computer-implemented method for processing spoken language to determine user intent for interaction with an automated agent, the method comprising: continuously monitoring ambient audio via a microphone integrated with a device; converting captured spoken words from the ambient audio into text using a speech-to-text conversion process; generating a structured prompt that includes, at least the converted text and an instruction for a Large Language Model (LLM), wherein the instruction is configured to request the LLM to infer whether the spoken words are intended for the automated agent; transmitting the structured prompt to the LLM; receiving, from the LLM, a structured output in a standardized format, wherein the structured output includes an inference result indicating whether the spoken words are intended for the automated agent and, if so, identifying the intent of the user; and executing an action by the automated agent based on the identified intent of the user when the inference result indicates that the spoken words are intended for the automated agent.

In Example 11, the subject matter of Example 10 includes, wherein the automated agent is a domain-specific automated agent and the method further comprises providing a system prompt distinct from the structured prompt as input to the LLM, the system prompt providing multi-shot fine-tuning examples to the LLM for a domain of the domain-specific automated agent, each example comprising a sample of spoken words and a corresponding structured output that indicates either a specific intent or absence of intent.

In Example 12, the subject matter of Example 11 includes, wherein the method further comprises providing a system prompt distinct from the structured prompt as input to the LLM, the system prompt including an instruction for the LLM to analyze a stream of text converted from spoken words to determine if the spoken words within the stream are directed towards the domain-specific automated agent or constitute ambient conversation, to extract the intent of the user from the spoken words intended for the domain-specific automated agent, and to generate a response in valid JavaScript Object Notation (JSON) format that indicates the extracted intent of the user without answering any questions posed within the stream of text.

In Example 13, the subject matter of Example 12 includes, wherein the structured output is in JSON format, and the structured output includes a field for the identified intent of the user that is populated when the inference result is positive.

In Example 14, the subject matter of Examples 10-13 includes, wherein the structured prompt further includes an instruction for the LLM to correct errors in the converted text using contextual information from previous interactions, and the method further comprises receiving a corrected text from the LLM as part of the structured output before executing an action by the automated agent.

In Example 15, the subject matter of Examples 10-14 includes, wherein the automated agent is integrated into an augmented reality (AR) device, and the action executed by the automated agent includes displaying relevant information via an application executing within an AR environment of the AR device.

In Example 16, the subject matter of Examples 10-15 includes, wherein the speech-to-text conversion process includes a pause detection feature that identifies the end of a spoken sentence and triggers transmission of the structured prompt to the LLM.

In Example 17, the subject matter of Examples 10-16 includes, wherein the LLM is configured to utilize a function calling capability that ensures the structured output is provided in a standardized format, the function calling capability enabling the LLM to execute predefined functions within the structured prompt that correspond to specific tasks, including correction of transcription errors resulting from the conversion of the captured spoken words from the ambient audio into text using the speech-to-text conversion process, and the inference of user intent from the text corresponding with the captured spoken words.

In Example 18, the subject matter of Examples 10-17 includes, wherein the automated agent is integrated into an automobile's infotainment system, and the action executed by the automated agent includes receiving spoken commands related to vehicle control functions, such as adjusting climate settings, setting navigation destinations, or activating windshield wipers, and wherein the LLM is fine-tuned to recognize and process commands specific to automotive operations.

Example 19 is a non-transitory computer-readable storage medium storing instructions that, when executed by at least one processor, cause the at least one processor to perform operations for processing spoken language to determine user intent for interaction with a domain-specific automated agent, the operations comprising: continuously monitoring ambient audio via a microphone integrated with a device; converting captured spoken words from the ambient audio into text using a speech-to-text conversion process; generating a structured prompt that includes, at least the converted text and an instruction for a Large Language Model (LLM), wherein the instruction is configured to request the LLM to infer whether the spoken words are intended for the domain-specific automated agent; transmitting the structured prompt to the LLM, wherein the LLM is fine-tuned to process prompts related to a domain of the domain-specific automated agent; receiving, from the LLM, a structured output in a standardized format, wherein the structured output includes an inference result indicating whether the spoken words are intended for the domain-specific automated agent and, if so, identifying the intent of the user; and executing an action by the domain-specific automated agent based on the identified intent of the user when the inference result indicates that the spoken words are intended for the domain-specific automated agent.

In Example 20, the subject matter of Example 19 includes, wherein the operations further comprise providing a system prompt distinct from the structured prompt as input to the LLM, the system prompt providing multi-shot fine-tuning examples to the LLM, each example comprising a sample of spoken words and a corresponding structured output that indicates either a specific intent or absence of intent.

Example 21 is at least one machine-readable medium including instructions that, when executed by processing circuitry, cause the processing circuitry to perform operations to implement of any of Examples 1-20.

Example 22 is an apparatus comprising means to implement of any of Examples 1-20.

Example 23 is a system to implement of any of Examples 1-20.

Example 24 is a method to implement of any of Examples 1-20.

What is claimed is:

1. A system for processing spoken language to determine user intent for interaction with an automated agent, the system comprising:
at least one processor;
at least one memory component storing instructions that, when executed by the at least one processor, cause the at least one processor to perform operations comprising:
continuously monitoring ambient audio via a microphone integrated with a device;
converting captured spoken words from the ambient audio into text using a speech-to-text conversion process;
generating a structured prompt that includes at least the converted text and an instruction for a Large Language Model (LLM), wherein the instruction is configured to request the LLM to infer whether the spoken words are intended for the automated agent;
transmitting the structured prompt to the LLM;
receiving, from the LLM, a structured output in a standardized format, wherein the structured output includes an inference result indicating whether the spoken words are intended for the automated agent and, if so, identifying the intent of the user; and
executing an action by the automated agent based on the identified intent of the user when the inference result indicates that the spoken words are intended for the automated agent.

2. The system of claim 1, wherein the automated agent is a domain-specific automated agent and the operations further comprise providing a system prompt distinct from the structured prompt as input to the LLM, the system prompt providing multi-shot fine-tuning examples to the LLM for a domain of the domain-specific automated agent, each example comprising a sample of spoken words and a corresponding structured output that indicates either a specific intent or absence of intent.

3. The system of claim 2, wherein the operations further comprise providing a system prompt distinct from the structured prompt as input to the LLM, the system prompt including an instruction for the LLM to analyze a stream of text converted from spoken words to determine if the spoken words within the stream are directed towards the domain-specific automated agent or constitute ambient conversation, to extract the intent of the user from the spoken words intended for the domain-specific automated agent, and to generate a response in valid JavaScript Object Notation (JSON) format that indicates the extracted intent of the user without answering any questions posed within the stream of text.

4. The system of claim 3, wherein the structured output is in JSON format, and the structured output includes a field for the identified intent of the user that is populated when the inference result is positive.

5. The system of claim 1, wherein the structured prompt further includes an instruction for the LLM to correct errors in the converted text using contextual information from previous interactions, and the operations further comprise receiving a corrected text from the LLM as part of the structured output before executing an action by the automated agent.

6. The system of claim 1, wherein the automated agent is integrated into an augmented reality (AR) device, and the action executed by the automated agent includes displaying relevant information via an application executing within an AR environment of the AR device.

7. The system of claim 1, wherein the speech-to-text conversion process includes a pause detection feature that identifies the end of a spoken sentence and triggers transmission of the structured prompt to the LLM.

8. The system of claim 1, wherein the LLM is configured to utilize a function calling capability that ensures the structured output is provided in a standardized format, the function calling capability enabling the LLM to execute predefined functions within the structured prompt that correspond to specific tasks, including correction of transcription errors resulting from the conversion of the captured spoken words from the ambient audio into text using the speech-to-text conversion process, and the inference of user intent from the text corresponding with the captured spoken words.

9. The system of claim 1, wherein the automated agent is integrated into an automobile's infotainment system, and the action executed by the automated agent includes receiving spoken commands related to vehicle control functions, such as adjusting climate settings, setting navigation destinations, or activating windshield wipers, and wherein the LLM is fine-tuned to recognize and process commands specific to automotive operations.

10. A computer-implemented method for processing spoken language to determine user intent for interaction with an automated agent, the method comprising:
continuously monitoring ambient audio via a microphone integrated with a device;
converting captured spoken words from the ambient audio into text using a speech-to-text conversion process;
generating a structured prompt that includes at least the converted text and an instruction for a Large Language Model (LLM), wherein the instruction is configured to request the LLM to infer whether the spoken words are intended for the automated agent;
transmitting the structured prompt to the LLM;
receiving, from the LLM, a structured output in a standardized format, wherein the structured output includes an inference result indicating whether the spoken words are intended for the automated agent and, if so, identifying the intent of the user; and
executing an action by the automated agent based on the identified intent of the user when the inference result indicates that the spoken words are intended for the automated agent.

11. The computer-implemented method of claim 10, wherein the automated agent is a domain-specific automated agent and the method further comprises providing a system prompt distinct from the structured prompt as input to the LLM, the system prompt providing multi-shot fine-tuning examples to the LLM for a domain of the domain-specific automated agent, each example comprising a sample of spoken words and a corresponding structured output that indicates either a specific intent or absence of intent.

12. The computer-implemented method of claim 11, wherein the method further comprises providing a system prompt distinct from the structured prompt as input to the LLM, the system prompt including an instruction for the LLM to analyze a stream of text converted from spoken words to determine if the spoken words within the stream are directed towards the domain-specific automated agent or constitute ambient conversation, to extract the intent of the user from the spoken words intended for the domain-specific automated agent, and to generate a response in valid JavaScript Object Notation (JSON) format that indicates the extracted intent of the user without answering any questions posed within the stream of text.

13. The computer-implemented method of claim 12, wherein the structured output is in JSON format, and the structured output includes a field for the identified intent of the user that is populated when the inference result is positive.

14. The computer-implemented method of claim 10, wherein the structured prompt further includes an instruction for the LLM to correct errors in the converted text using contextual information from previous interactions, and the method further comprises receiving a corrected text from the LLM as part of the structured output before executing an action by the automated agent.

15. The computer-implemented method of claim 10, wherein the automated agent is integrated into an augmented reality (AR) device, and the action executed by the automated agent includes displaying relevant information via an application executing within an AR environment of the AR device.

16. The computer-implemented method of claim 10, wherein the speech-to-text conversion process includes a pause detection feature that identifies the end of a spoken sentence and triggers transmission of the structured prompt to the LLM.

17. The computer-implemented method of claim 10, wherein the LLM is configured to utilize a function calling capability that ensures the structured output is provided in a standardized format, the function calling capability enabling the LLM to execute predefined functions within the structured prompt that correspond to specific tasks, including correction of transcription errors resulting from the conversion of the captured spoken words from the ambient audio into text using the speech-to-text conversion process, and the inference of user intent from the text corresponding with the captured spoken words.

18. The computer-implemented method of claim 10, wherein the automated agent is integrated into an automobile's infotainment system, and the action executed by the automated agent includes receiving spoken commands related to vehicle control functions, such as adjusting climate settings, setting navigation destinations, or activating windshield wipers, and wherein the LLM is fine-tuned to recognize and process commands specific to automotive operations.

19. A non-transitory computer-readable storage medium storing instructions that, when executed by at least one processor, cause the at least one processor to perform operations for processing spoken language to determine user intent for interaction with a domain-specific automated agent, the operations comprising:
continuously monitoring ambient audio via a microphone integrated with a device;
converting captured spoken words from the ambient audio into text using a speech-to-text conversion process;
generating a structured prompt that includes at least the converted text and an instruction for a Large Language Model (LLM), wherein the instruction is configured to request the LLM to infer whether the spoken words are intended for the domain-specific automated agent;
transmitting the structured prompt to the LLM, wherein the LLM is fine-tuned to process prompts related to a domain of the domain-specific automated agent;
receiving, from the LLM, a structured output in a standardized format, wherein the structured output includes an inference result indicating whether the spoken words are intended for the domain-specific automated agent and, if so, identifying the intent of the user; and
executing an action by the domain-specific automated agent based on the identified intent of the user when the inference result indicates that the spoken words are intended for the domain-specific automated agent.

20. The non-transitory computer-readable medium of claim 19, wherein the operations further comprise providing a system prompt distinct from the structured prompt as input to the LLM, the system prompt providing multi-shot fine-tuning examples to the LLM, each example comprising a sample of spoken words and a corresponding structured output that indicates either a specific intent or absence of intent.
